(19) United States
(12) Patent Application Publication
(10) Pub. No.: US 2017/0105230 A1
(43) Pub. Date: Apr. 13, 2017

(54) COMMUNICATION CONTROL METHOD AND USER TERMINAL

(71) Applicant: KYOCERA CORPORATION, Kyoto (JP)

(72) Inventors: Naohisa MATSUMOTO, Kawasaki-shi, Kanagawa (JP); Hiroyuki ADACHI, Kawasaki-shi, Kanagawa (JP); Kugo MORITA, Yokohama-shi, Kanagawa (JP); Masato FUJISHIRO, Yokohama-shi, Kanagawa (JP)

(73) Assignee: KYOCERA CORPORATION, Kyoto (JP)

(21) Appl. No.: 15/126,186

(22) PCT Filed: Mar. 18, 2015
(86) PCT No.: PCT/JP2015/058063

§ 371 Date: Sep. 14, 2016

(30) Foreign Application Priority Data
Mar. 20, 2014 (JP) 2014-059276

(51) Int. Cl. H04W 72/12; H04W 72/04; H04L 5/00

(52) U.S. Cl. CPC H04W 72/1278; H04L 5/0037; H04W 72/04; H04W 92/18

(57) ABSTRACT

In the communication control method according to the present embodiment, a user terminal receives a scheduling assignment indicating a location of a radio resource used in a reception of communication data by direct device-to-device communication. The user terminal decides a terminal identifier that is different from a terminal identifier indicating another user terminal included in the scheduling assignment, as a terminal identifier indicating the user terminal. The user terminal transmits a scheduling assignment including the decided terminal identifier.

### TECHNICAL FIELD

The present invention relates to a communication control method and a user terminal used in a mobile communication system.

### BACKGROUND ART

In 3GPP (3rd Generation Partnership Project) which is a project aiming to standardize a mobile communication system, the introduction of a Device to Device (D2D) proximity service is discussed as a new function in Release 12 and later (see Non Patent Document 1).

The D2D proximity service (D2D ProSe) is a service enabling direct device-to-device communication within a synchronization cluster formed by a plurality of synchronized user terminals. The D2D proximity service includes a D2D discovery procedure (Discovery) in which a proximal terminal is discovered, and D2D communication (Communication) that is direct device-to-device communication.

However, in order to notify a radio resource for transmitting D2D communication data, the user terminal transmits a scheduling assignment indicating a location of the radio resource.

### PRIOR ART DOCUMENT

### Non-Patent Document

Non Patent Document 1: 3GPP technical report “TR 36.843 V1.2.0” Mar. 10, 2014

### SUMMARY

In a communication control method according to one embodiment, a user terminal receives a scheduling assignment indicating a location of a radio resource used in a reception of communication data by direct device-to-device communication. The user terminal decides a terminal identifier that is different from a terminal identifier indicating another user terminal included in the scheduling assignment, as a terminal identifier indicating the user terminal. The user terminal transmits a scheduling assignment including the decided terminal identifier.

In a communication control method according to one embodiment, a user terminal periodically transmits a scheduling assignment indicating a location of a radio resource used in a reception of communication data by direct device-to-device communication. The scheduling assignment includes a number corresponding to a transmission order of the scheduling assignment.

In a communication control method according to one embodiment, a user terminal divides a unique identifier indicating the user terminal into a plurality of identifiers. The user terminal transmits any one of the plurality of identifiers by including the one of the plurality of identifiers into each of a plurality of scheduling assignments indicating a location of the same radio resource used in a reception of communication data by direct device-to-device communication. The user terminal transmits the communication data after transmitting all of the plurality of identifiers.

A user terminal according to one embodiment comprises: a controller configured to receive a scheduling assignment indicating a location of a radio resource used in a reception of communication data by direct device-to-device communication. The controller decides a terminal identifier that is different from a terminal identifier indicating another user terminal included in the scheduling assignment, as a terminal identifier indicating the user terminal. The controller transmits a scheduling assignment including the decided terminal identifier.

A user terminal according to one embodiment comprises: a transmitter configured to periodically transmit a scheduling assignment indicating a location of a radio resource used in a reception of communication data by direct device-to-device communication. The scheduling assignment includes a number corresponding to a transmission order of the scheduling assignment.

### BRIEF DESCRIPTION OF THE DRAWINGS

FIG. 1 is a configuration diagram of an LTE system according to an embodiment.

FIG. 2 is a block diagram of a UE according to the embodiment.

FIG. 3 is a block diagram of an eNB according to the embodiment.

FIG. 4 is a protocol stack diagram according to the embodiment.

FIG. 5 is a configuration diagram of a radio frame according to the embodiment.

FIG. 6 is a diagram for describing a scheduling assignment according to the embodiment.

FIG. 7 is a diagram for describing an operation pattern 4 according to the embodiment.

FIG. 8 is a diagram (part 1) for describing an operation pattern 6 according to the embodiment.

FIG. 9 is a diagram (part 2) for describing the operation pattern 6 according to the embodiment.

### DESCRIPTION OF THE EMBODIMENT

### Overview of Embodiments

Here, a case is assumed where a reception-side user terminal receives a scheduling assignment from a transmission-side user terminal, which is a partner terminal of the D2D communication, uses a radio resource indicated by the scheduling assignment, and then receives D2D communication data from the transmission-side user terminal.

In such a case, the reception-side user terminal is likely to receive not only the scheduling assignment from the transmission-side user terminal, but also a scheduling assignment from another transmission-side user terminal that is not a partner terminal of the D2D communication. In this case, it is feared that the reception-side user terminal may accidentally receive D2D communication data from the another transmission-side user terminal without knowing which of the two received scheduling assignments is the scheduling assignment from the transmission-side user terminal.

Embodiments enable a reception-side user terminal to receive appropriate D2D communication data when the D2D communication data is received, on the basis of a scheduling assignment received from a transmission-side user terminal.

In a communication control method according to embodiments, a user terminal receives a scheduling assignment indicating a location of a radio resource used in a reception of communication data by direct device-to-device communication. The user terminal decides a terminal identifier that is different from a terminal identifier indicating another user terminal included in the scheduling assignment, as a terminal identifier indicating the user terminal. The user terminal transmits a scheduling assignment including the decided terminal identifier.

In the embodiments, the user terminal decides a terminal identifier candidate that is different from the terminal identifier indicating the another user terminal from among a plurality of terminal identifier candidates, as the terminal identifier indicating the user terminal.

In the embodiments, when a terminal identifier candidate decided beforehand is different from the terminal identifier indicating the another user terminal, the user terminal decides the terminal identifier candidate as the terminal identifier indicating the user terminal.

In the embodiments, when the terminal identifier candidate decided beforehand is same as the terminal identifier indicating the another user terminal, the user terminal decides a new terminal identifier that is different from the terminal identifier candidate, as the terminal identifier indicating the user terminal.

In the embodiments, the user terminal transmits a number corresponding to a transmission order of each of a plurality of communication data, together with each of the plurality of communication data transmitted by direct device-to-device communication.

In a communication control method according to the embodiments, a user terminal periodically transmits a scheduling assignment indicating a location of a radio resource used in a reception of communication data by direct device-to-device communication. The scheduling assignment includes a number corresponding to a transmission order of the scheduling assignment.

In the embodiments, the user terminal includes an initial number decided on the basis of a random number, into the scheduling assignment that is initially transmitted.

In the embodiments, the user terminal further includes the terminal identifier indicating the user terminal, into the scheduling assignment. The terminal identifier is generated by reducing the size of a unique identifier of the user terminal so that a total amount of information of the number and the terminal identifier becomes equal to or less than a threshold value.

In a communication control method according to the embodiments, a user terminal divides a unique identifier indicating the user terminal into a plurality of identifiers. The user terminal transmits one of the plurality of identifiers by including the one of the plurality of identifiers into one of a plurality of scheduling assignments indicating a location of the same radio resource used in a reception of communication data by direct device-to-device communication. The user terminal transmits the communication data after transmitting all of the plurality of identifiers.

A user terminal according to the embodiments comprises: a controller configured to receive a scheduling assignment indicating a location of a radio resource used in a reception of communication data by direct device-to-device communication. The controller decides a terminal identifier that is different from a terminal identifier indicating another user terminal included in the scheduling assignment, as a terminal identifier indicating the user terminal. The controller transmits a scheduling assignment including the decided terminal identifier.

A user terminal according to the embodiments comprises: a transmitter configured to periodically transmit a scheduling assignment indicating a location of a radio resource used in a reception of communication data by direct device-to-device communication. The scheduling assignment includes a number corresponding to a transmission order of the scheduling assignment.

### Embodiment

An embodiment of applying the present invention to a LTE system will be described below.

(System Configuration)

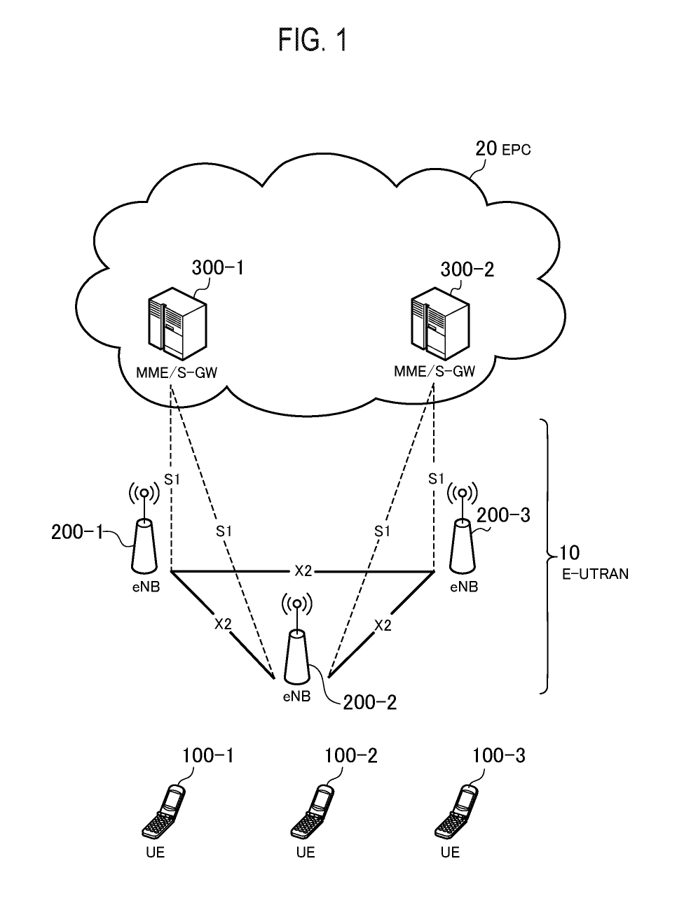

FIG. 1 is a configuration diagram of the LTE system according to the embodiment. As illustrated in FIG. 1, the LTE system according to the embodiment includes a plurality of UEs (User Equipments) 100, E-UTRAN (Evolved-UMTS Terrestrial Radio Access Network) 10, and EPC (Evolved Packet Core) 20.

The UE 100 corresponds to a user terminal. The UE 100 is a mobile communication device and performs radio communication with a cell (a serving cell) with which a connection is established. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface. Configuration of the eNB 200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The network of the LTE system (LTE network) is constituted by the E-UTRAN 10 and the EPC 20. The EPC 20 includes a plurality of MME (Mobility Management Entity)/S-GWs (Serving-Gateways) 300. The MME performs various mobility controls and the like for the UE 100. The S-GW performs control to transfer user. MME/S-GW 300 is connected to eNB 200 via an S1 interface.

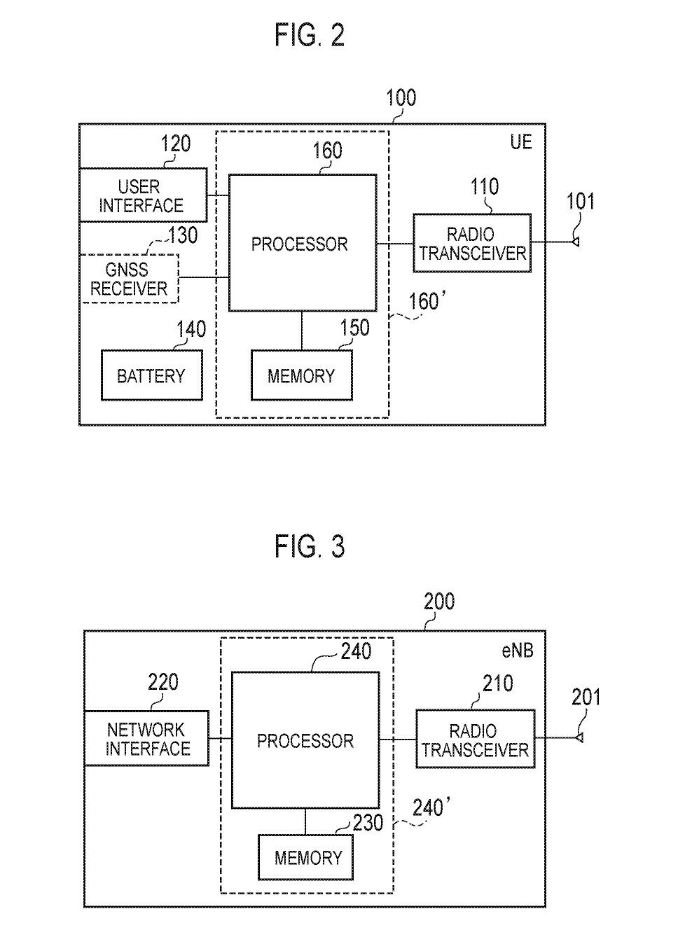

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 corresponds to a storage and the processor 160 corresponds to a controller. The UE 100 may not have the GNSS receiver 130. Furthermore, the memory 150 may be integrally formed with the processor 160, and this set (that is, a chip set) may be called a processor 160′ which constitutes the controller.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. Further, the memory 230 may be integrally formed with the processor 240, and this set (that is, a chipset) may be called a processor 240′ which constitute the controller.

The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

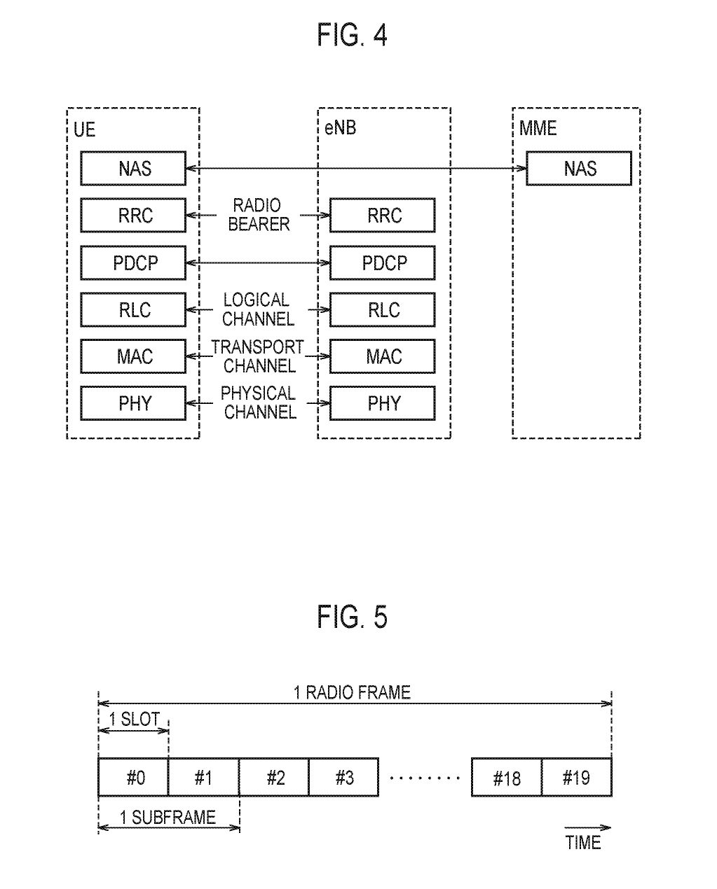

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, use data and control signal are transmitted via the physical channel.

The MAC layer performs priority control of data, a retransmission process by hybrid ARQ (HARQ), a random access procedure at the time of RRC connection establishment and the like. Between the MAC layer of the UE 100 and the MAC layer of the eNB 200, user data and control signal are transmitted via a transport channel. The MAC layer of the eNB 200 includes a scheduler that determines (schedules) a transport format of an uplink and a downlink (a transport block size and a modulation and coding scheme) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control signal (RRC messages) for various types of configuration are transmitted. The RRC layer controls the logical channel, the transport channel, and the physical channel in response to establishment, re-establishment, and release of a radio bearer. When there is an RRC connection between the RRC of the UE 100 and the RRC of the eNB 200, the UE 100 is in an RRC connected state, otherwise the UE 100 is in an RRC idle state.

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiple Access) is applied to a downlink (DL), and SC-FDMA (Single Carrier Frequency Division Multiple Access) is applied to an uplink (UL), respectively.

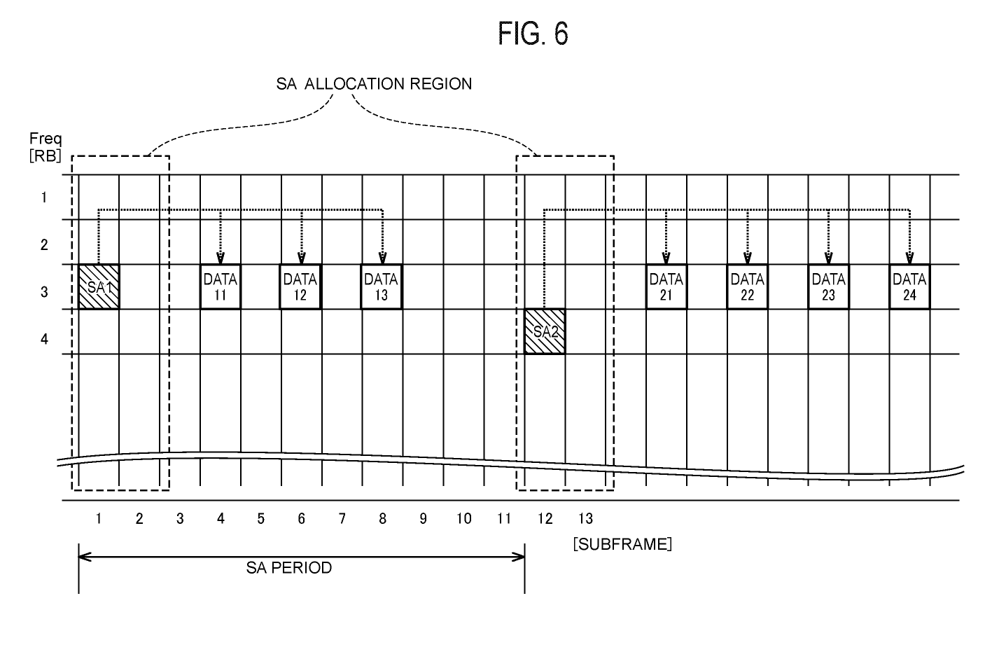

As illustrated in FIG. 6, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. A resource element is constituted by one subframe and one symbol. Among radio resources (time-frequency resources) assigned to the UE 100, a frequency resource is constituted by a resource block and a time resource is constituted by a subframe (or slot).

(D2D Proximity Service)

A D2D proximity service will be described, below. The LTE system according to the embodiment supports the D2D proximity service. The D2D proximity service is described in Non Patent Document 1, and an outline thereof will be described here.

The D2D proximity service (D2D ProSe) is a service enabling direct UE-to-UE communication within a synchronization cluster formed by a plurality of synchronized UEs 100. The D2D proximity service includes a D2D discovery procedure (Discovery) in which a proximal UE is discovered and, D2D communication (Communication) that is direct UE-to-UE communication. The D2D communication is also called Direct communication.

A scenario in which all the UEs 100 forming the synchronization cluster are located in a cell coverage is called “In coverage”. A scenario in which all the UEs 100 forming the synchronization cluster are located out of a cell coverage is called “Out of coverage”. A scenario in which some UEs 100 in the synchronization cluster are located in a cell coverage and the remaining UEs 100 are located out of the cell coverage is called “Partial coverage”.

In “In coverage”, the eNB 200 is a D2D synchronization source, for example. A D2D asynchronization source is synchronized with the D2D synchronization source without transmitting a D2D synchronization signal. The eNB 200 that is a D2D synchronization source transmits, by a broadcast signal, D2D resource information indicating a radio resource available for the D2D proximity service. The D2D resource information includes information indicating a radio resource available for the D2D discovery procedure (Discovery resource information) and information indicating a radio resource available for the D2D communication (Communication resource information), for example. The UE 100 that is a D2D asynchronization source performs the D2D discovery procedure and the D2D communication on the basis of the D2D resource information received from the eNB 200.

In “Out of coverage” or “Partial coverage”, the UE 100 is a D2D synchronization source, for example. In “Out of coverage”, the UE 100 that is a D2D synchronization source transmits D2D resource information indicating a radio resource available for the D2D proximity service, by a D2D synchronization signal, for example. The D2D synchronization signal is a signal transmitted in a D2D synchronization procedure in which device-to-device synchronization is established. The D2D synchronization signal includes a D2DSS and a physical D2D synchronization channel (PD2DSCH). The D2DSS is a signal for providing a synchronization standard of a time and a frequency. The PD2DSCH is a physical channel through which more information is conveyed than the D2DSS. The PD2DSCH conveys the above-described D2D resource information (Discovery resource information, Communication resource information). Alternatively, when the D2DSS is associated with the D2D resource information, the PD2DSCH may be rendered unnecessary.

The D2D discovery procedure is used mainly when the D2D communication is performed by unicast. One UE 100 uses any particular radio resource out of radio resources available for the D2D discovery procedure when starting the D2D communication with another UE 100 to transmit a Discovery signal. The another UE 100 scans the Discovery signal within the radio resource available for the D2D discovery procedure when starting the D2D communication with the one UE 100 to receive the Discovery signal. The Discovery signal may include information indicating a radio resource used by the one UE 100 for the D2D communication.

(Scheduling Assignment)

A scheduling assignment (SA) will be described below by using FIG. 6. FIG. 6 is a diagram for describing the scheduling assignment according to the embodiment.

The UE 100 transmits a scheduling assignment when performing D2D broadcast communication in which a transmission destination is not specified. Specifically, the UE 100 transmits a scheduling assignment by using a radio resource from a periodically arranged SA allocation region. A part of the D2D resource pool for the D2D communication data is set as a resource pool for the SA allocation region. A period from one SA allocation region up to before the next SA allocation region is one SA cycle.

Here, the scheduling assignment indicates a location of a radio resource for the reception of the D2D communication data (hereinafter, appropriately called a D2D data resource). Specifically, as shown in FIG. 6, the scheduling assignment SA 1 indicates locations of radio resources used in the D2D communication data DATA 11, DATA 12, and DATA 13. The scheduling assignment preferably indicates the location of a plurality of D2D data resources. The scheduling assignment preferably indicates the location of the D2D data resources on the basis of the location of the scheduling assignment. As a result, it is possible to reduce the number of bits for indicating the location of the D2D data resources. For example, when the scheduling assignment specifies a D2D data resource like “UL resource allocation type 0” of “DCI format 0”, a maximum of 13 bits are necessary for assignment in a frequency direction, but by indicating the location of the D2D data resource on the basis of the location of the scheduling assignment, it is possible to reduce the number of bits to be less than 13 bits.

In order to indicate the location of the D2D data resource on the basis of the location of the scheduling assignment, for example, it is preferable to fix an offset from the location of the scheduling assignment up to the location of the D2D data resource, and fix an interval of each D2D data resource for which one scheduling assignment indicates the location, and also fix a width (RB width) of the D2D data resource in the frequency direction. For example, the width of the D2D data resource in the frequency direction may be fixed to the width of two resource blocks.

It is preferable to code the scheduling assignment by using a Tailbiting convolutional code (TBCC) rather than a turbo code. This is because when the TBCC has a smaller bit size than the turbo code, the linking performance is expected to be good. Another reason is that TBCC is used for coding a PDCCH (DCI) as well.

Here, it is assumed that in order to enable a reception UE to designate a transmission UE, which is a transmission source of the scheduling assignment, the transmission UE transmits a scheduling assignment including a UE identifier (UEID) indicating a UE that is the transmission source of the scheduling assignment.

However, the D2D proximity service including the D2D discovery procedure and the D2D communication is controlled not only by an eNB, but also by a UE. Therefore, as in the case of a conventional cellular system, the eNB is not capable of managing the UEID. In addition, since the D2D proximity service supports communication spanning between eNBs (Inter-cell/eNB), one eNB is not capable of independently managing the ID as in the case of the conventional cellular system.

Therefore, it is feared that a UEID included into the scheduling assignment by the transmission UE may overlap a UEID included into the scheduling assignment by another transmission UE. When the UEID overlaps, it is likely that the reception UE is not capable of receiving normal D2D communication data due to radio interference, for example.

On the other hand, there is a problem that overhead increases, when the transmission UE includes a UE unique ID (for example, a telephone number or a MAC address) uniquely indicating the transmission UE into the scheduling assignment.

In order to avoid such a problem to the possible extent, an operation according to an embodiment described below is performed.

### Operation According to Embodiment

Next, operation patterns 1 to 6 according to the embodiment will be described. It is noted that the UE identifier (UEID) described below is an identifier in a PHY layer.

(A) Operation Pattern 1

In the operation pattern 1, a UE 100-1 includes, into the scheduling assignment, a UE identifier (UEID) that is different from a UEID included in the scheduling assignment transmitted by another UE 100, on the basis of a scan result of the SA allocation region.

Firstly, the UE 100-1 that is scheduled to transmit the D2D communication data scans a predetermined SA allocation region in order to receive the scheduling assignment. As a result, the UE 100 receives the scheduling assignment.

Secondly, on the basis of the scan result, the UE 100-1 decides the UEID indicating the UE 100-1 so as to be different from the UEID indicating another UE that is included in the received scheduling assignment.

The UE 100-1, for example, extracts a UEID candidate that is different from the UEID indicating another UE, from a plurality of UEID candidates set beforehand. If there is one extracted UEID, the extracted UEID is decided to be the UEID indicating the UE 100-1. On the other hand, if there are a plurality of extracted UEID candidates, the UEID is decided by using a unique value held by the UE 100-1. For example, when there are N number of UEID candidates, the unique value is A, and the m^{th} UEID candidate is the UEID (m), the UE 100-1 decides the n^{th} UEID candidate that satisfies the expression “UEID (n): n=A mod N” as the UEID.

Alternatively, by performing an operation of reducing to a predetermined number of bits (for example 16 bits) for the UE unique ID (for example, a telephone number), the UE 100-1 decides beforehand the UE unique ID as a UEID candidate to be included into the scheduling assignment. The UE 100-1 may perform this process before performing scanning.

The UE 100-1 determines whether or not the UEID candidate decided beforehand is same as the UEID indicating another UE. If the UEID candidate decided beforehand is different from the UEID indicating the another UE, the overlapping of the UEID with the another UE is not assumed, and therefore, the UEID candidate decided beforehand is decided to be the UEID indicating the UE 100-1. On the other hand, if the UEID candidate decided beforehand is same as the UEID indicating the another UE, the overlapping of the UEID with the another UE is assumed, and therefore, the UE 100-1 changes to a new UEID instead of the UEID candidate decided beforehand, by using a predetermined method. The UE 100-1 decides the changed UEID to be the UEID indicating the UE 100-1.

Thirdly, the UE 100-1 transmits a scheduling assignment including the decided UEID by using a radio resource from the next scanned SA allocation region. As a result, the UE that has received the scheduling assignment from the UE 100-1 is capable of differentiating the scheduling assignment from the scheduling assignment of the another UE on the basis of the UEID included in the scheduling assignment. Further, due to the periodic continuous transmission of the scheduling assignment including the decided UEID by the UE 100-1, another UE 100-2 that starts the transmission of new D2D communication data avoids deciding the same UEID as the UEID of the UE 100-1 by scanning the SA allocation region. As a result, the UE that receives the D2D communication data from the UE 100-1 is capable of appropriately receiving the D2D communication data from the UE 100-1.

It is noted that when the UE 100-1 transmits a series of D2D communication data by dividing into a plurality of D2D communication data, the UE 100-1 may transmit a sequence number corresponding to the transmission order of each of the plurality of D2D communication data together with each of the plurality of D2D communication data. For example, the UE 100-1 transmits an initial D2D communication data and the sequence number 1 as a set, the next D2D communication data and the sequence number 2 as a set, and the nth D2D communication data and the sequence number n as a set. As a result, even upon receiving the D2D communication data of another UE, the UE that receives the D2D communication data from the UE 100-1 is capable of determining that the D2D communication data is from a UE different from the UE 100-1 by detecting the discontinuity of the sequence number.

It is noted that the sequence number may be a sequence number in an RLC layer.

(B) Operation Pattern 2

In the operation pattern 2, the UE 100-1 periodically transmits a scheduling assignment including a sequence number corresponding to the transmission order of the scheduling assignment.

Firstly, before transmitting an initial scheduling assignment, the UE 100-1 decides an initial value of the sequence number. The UE 100-1 may decide the initial value of the sequence number on the basis of a random number. That is, the UE 100-1 is capable of randomly starting the initial value of the sequence number. As a result, it is possible to mitigate the overlapping of the sequence number with a sequence number included in another scheduling assignment.

Secondly, the UE 100-1 transmits the initial scheduling assignment including the initial value of the decided sequence number. Next, the UE 100-1 periodically transmits a scheduling assignment including a sequence number corresponding to the transmission order of the scheduling assignment. For example, the UE 100-1 transmits the initial scheduling assignment including the sequence number n. Next, the UE 100-1 transmits a scheduling assignment including the sequence number n+1. When transmitting the mth scheduling assignment, the UE 100-1 transmits a scheduling assignment including the sequence number n+m. As a result, since the sequence number performs the same role as the above-described UEID indicating the UE 100-1, the UE that has received the scheduling assignment from the UE 100-1 is capable of differentiating the scheduling assignment from the scheduling assignment of another UE on the basis of the sequence number included in the scheduling assignment. Specifically, when the UE that has received the scheduling assignment detects a discontinuity of the sequence number, the UE is capable of determining that the scheduling assignment in which the sequence number is included is a scheduling assignment from a UE that is different from the UE 100-1.

(C) Operation Pattern 3

In the operation pattern 3, the UE 100-1 transmits a scheduling assignment including a sequence number corresponding to the transmission order of the scheduling assignment, and a UEID.

Firstly, the UE 100-1 decides an initial value of the sequence number, similarly to the above-described operation pattern 1.

Secondly, the UE 100-1 decides the UEID indicating the UE 100-1. For example, the UE 100-1 generates the UEID by performing an operation of reducing the UE unique ID (for example, the telephone number) so that the total amount of information of the sequence number and the UEID becomes equal to or less than a threshold value (for example, 16 bits).

Thirdly, the UE 100-1 periodically transmits a scheduling assignment including the sequence number and the generated UEID. Similarly to the above-described operation pattern 2, the sequence number corresponds to the transmission order of the scheduling assignment. As a result, the UE that has received the scheduling assignment is capable of differentiating the scheduling assignment from the scheduling assignment of the another UE on the basis of the sequence number and the UEID.

(D) Operation Pattern 4

In the operation pattern 4, the UE 100-1 fixes, within each SA allocation region, a location of a radio resource that transmits the scheduling assignment.

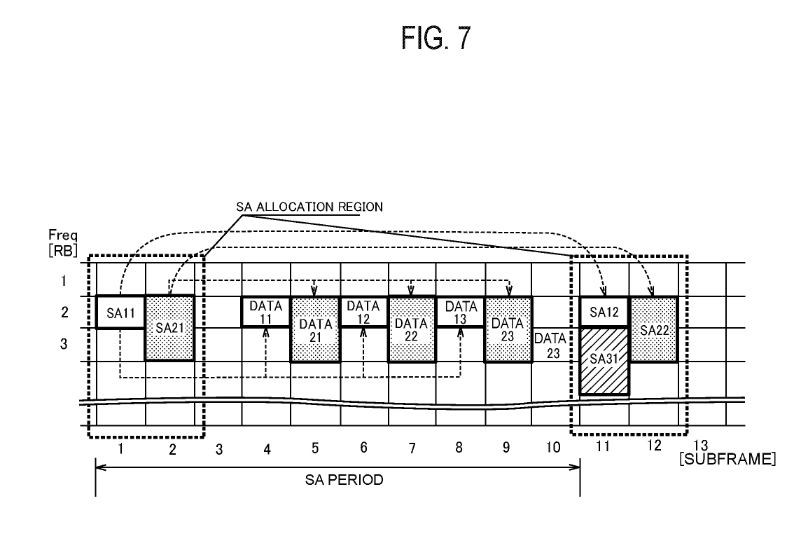

Firstly, the UE 100-1 transmits a first scheduling assignment (SA 11) (see FIG. 7). The SA 11 indicates the locations of the D2D data resources DATA 11, DATA 12, and DATA 13. The UE 100-2 transmits a first scheduling assignment (SA 21). The SA 21 indicates the locations of the D2D data resources DATA 21, DATA 22, and DATA 23.

On the other hand, a UE 100-3 that is scheduled to transmit the D2D communication data scans the SA allocation region in a subframe 1-2. As a result of the scan, the UE 100-3 understands the location of the radio resource used in the transmission of the scheduling assignment.

Next, the UE 100-1 transmits the DATA 11, the DATA 12, and the DATA 13 by using the D2D data resource of which the location is indicated by the SA 11. Similarly, the UE 100-2 transmits the DATA 21, the DATA 22, and the DATA 23 by using the D2D data resource of which the location is indicated by the SA 21.

Secondly, the UE 100-1 transmits a second scheduling assignment (SA 12) by using a radio resource having a (relatively) same location as the SA 11, within the next SA allocation region. The UE 100-2 transmits a second scheduling assignment (SA 22) by using a radio resource having a (relatively) same location as the SA 21, within the next SA allocation region. Therefore, each of the UE 100-1 and the UE 100-2 transmits, within each SA allocation region, a scheduling assignment by using a radio resource of which the location is fixed.

On the other hand, the UE 100-3 that is scheduled to transmit the D2D communication data transmits, within the next SA assignment region, a scheduling assignment (SA 31) by using a radio resource that is different from the radio resource having a (relatively) same location as the radio resource used in the transmission of the scheduling assignment.

In this way, since the location of the radio resource that transmits the scheduling assignment is fixed, it is possible to determine whether or not the D2D communication data is from a UE that is different from the UE 100-1 on the basis of the location of the scheduling assignment, even if the same UEID is included in a plurality of scheduling assignments.

(E) Operation Pattern 5

In the operation pattern 5, the UE 100-1 includes information indicating a location of a radio resource to be used in the transmission of the next scheduling assignment, into the scheduling assignment.

Firstly, before transmitting a scheduling assignment, the UE 100-1 decides the location of the radio resource to be used in the next scheduling assignment.

Secondly, the UE 100-1 transmits the scheduling assignment by including the information indicating the location of the radio resource to be used in the next scheduling assignment, into the scheduling assignment. Thus, the UE that has received the scheduling assignment from the UE 100-1 understands the location of the radio resource to be used in the next scheduling assignment. As a result, the UE that has received the scheduling assignment is capable of receiving the next scheduling assignment from the UE 100-1 rather than the scheduling assignment from another UE, which enables the UE to appropriately receive a series of the D2D communication data from the UE 100-1.

(F) Operation Pattern 6

In the operation pattern 6, the UE 100-1 divides a unique identifier maintained by the UE 100-1, includes the divided identifiers into each of a plurality of scheduling assignments indicating the location of the same D2D data resource, and transmits the plurality of scheduling assignments.

Firstly, the UE 100-1 divides a unique identifier maintained by the UE 100-1 (UE unique ID) into a plurality of identifiers (a plurality of division IDs). Specifically, the UE 100-1 divides the UE unique ID into the number of a plurality of scheduling assignments indicating the location of the same D2D data resource described later.

The UE unique ID is, for example, a telephone number, a MAC address, or the like of the UE 100-1. The UE unique ID is preferably the one that is set beforehand (pre-configured).

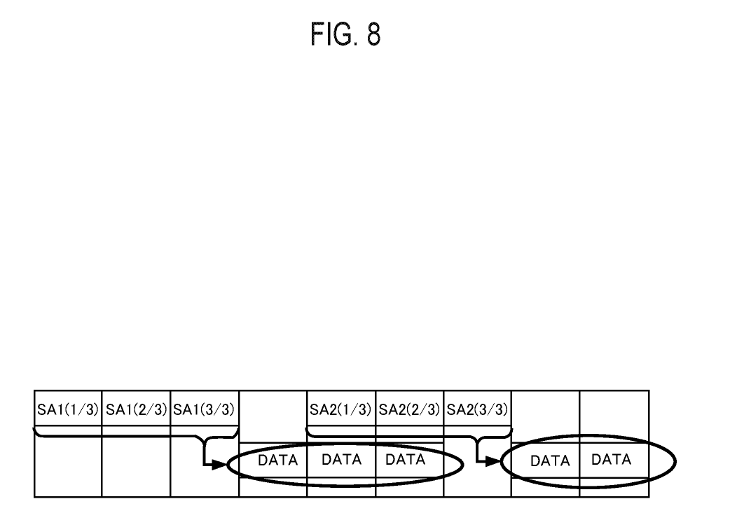

Secondly, as shown in FIG. 8, the UE 100-1 transmits the plurality of scheduling assignments (for example, each SA 1) indicating the same D2D data resource. For example, the UE 100-1 performs repeated transmission of the scheduling assignment. The UE 100-1 may transmit a predetermined scheduling assignment (SA 1 (1/3)), and may retransmit a scheduling assignment (SA 1 (2/3), SA 1 (3/3)) that is the same as the predetermined scheduling assignment. Alternatively, the UE 100-1 may retransmit a predetermined scheduling assignment by a blind HARQ that is retransmitted regardless of whether or not the reception UE receives the predetermined scheduling assignment.

The scheduling assignment includes a division ID. The UE 100-1 associates the transmission order of each of the plurality of scheduling assignments and the arrangement of the plurality of division IDs (that is, the arrangement in which the arrangement of the plurality of division IDs becomes the UE unique ID), and then includes the division ID into each of the plurality of scheduling assignments.

It is noted that the scheduling assignment may include an identifier indicating a reception-destination UE.

Thirdly, the reception UE receives the scheduling assignment. The reception UE receives the D2D communication data by using the D2D resource of the location indicated by the scheduling assignment.

Upon being successful in receiving the scheduling assignment (for example, SA 1 (1/3)), the reception UE may stop the scan for receiving the scheduling assignment, and may not receive the remaining scheduling assignments (for example, SA 1 (2/3) and SA 1 (3/3)).

According to the operation pattern 6, since the UE 100-1 transmits the plurality of scheduling assignments indicating the same D2D data resource, the reception UE is capable of receiving the scheduling assignment more reliably.

Further, while the UE 100-1 is capable of receiving the appropriate D2D communication data by using the UE unique ID, it is possible to prevent an increase in overhead.

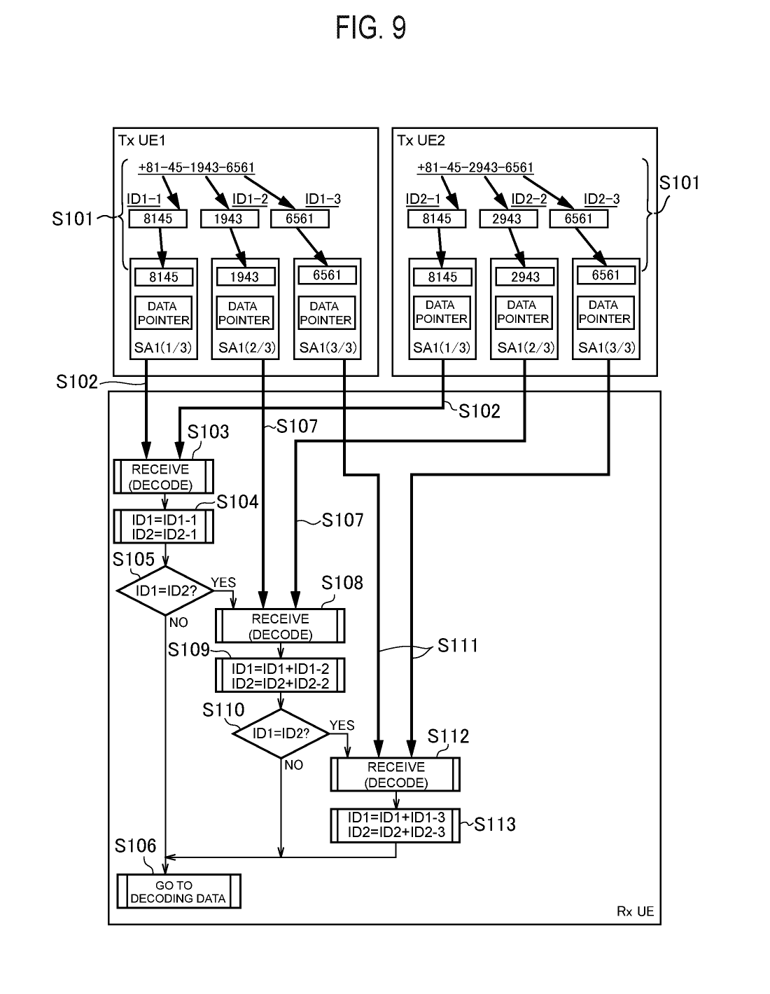

Next, an example of a specific operation of the transmission UEs (Tx UE 1, Tx UE 2) and the reception UE (Rx UE) will be described by using FIG. 9.

In step S101, the transmission UE divides a UE unique ID maintained by the transmission UE into a plurality of division IDs, and includes the division IDs into each of a plurality of scheduling assignments.

Specifically, a transmission UE 1 divides a telephone number (+81-45-1943-6561), which is a UE unique ID, into three, which is the number of the scheduling assignments scheduled to be transmitted. As a result, the UE unique ID is divided into a division ID 1-1 indicating “8145”, a division ID 1-2 indicating “1943”, and a division ID 1-3 indicating “6561”.

The transmission UE 1 includes each division ID into each of the plurality of scheduling assignments (SA 1 (1/3), SA 1 (2/3), SA 1 (3/3)). The transmission UE 1 associates the transmission order of the plurality of scheduling assignments and the order of the division IDs (the arrangement of the division IDs). As a result, the SA 1 (1/3) includes the division ID 1-1, the SA 1 (2/3) includes the division ID 1-2, and the SA 1 (3/3) includes the division ID 1-3.

It is noted that information (Data pointer) indicating the location of the D2D data resource included in each of the SA 1 (1/3) to SA 1 (3/3) indicates the same location.

Similarly to the transmission UE 1, a transmission UE 2 divides a UE unique ID, and includes the division IDs into each of a plurality of scheduling assignments. As a result, the SA 1 (1/3) includes the division ID 2-1 indicating “8145”, the SA 1 (2/3) includes the division ID 2-2 indicating “2943”, and the SA 1 (3/3) includes the division ID 2-3 indicating “6561”.

In step S102, the transmission UE transmits the SA 1 (1/3) by using the D2D data resource from a predetermined SA allocation region. The transmission UE 1 transmits the SA 1 (1/3) by using (an initial D2D data resource from) an initial D2D data resource. The transmission UE 2 transmits the SA 1 (1/3) by using (an initial D2D data resource from) a second D2D data resource.

In step S103, the reception UE receives the SA 1 (1/3) from each of the transmission UE 1 and the transmission UE 2, and decodes the received SA 1 (1/3).

In step S104, the reception UE considers the ID 1-1 included in the SA 1 (1/3) that is received by using the first D2D data resource as an ID 1, and considers the ID 2-1 included in the SA 1 (1/3) that is received by using the second D2D data resource as an ID 2.

In step S105, the reception UE determines whether or not the ID 1 and the ID 2 are the same. When the ID 1 and the ID 2 are not the same (in the case of “No”), the reception UE executes a process of step S106, and when the ID 1 and the ID 2 are the same (in the case of “Yes”), the reception UE executes a process of step S108.

In the present embodiment, the ID 1 and the ID 2 indicates “8145”, which means the ID 1 and the ID 2 are the same, and thus, the reception UE executes the process of step S108.

In step S106, the reception UE receives the D2D communication data by using the D2D data resource indicated by the SA transmitted by the transmission UE that is desired to be received. The reception UE may not execute processes thereafter (steps S108 to S110, S112, and S113).

In step S107, the transmission UE transmits the SA 1 (2/3) by using the D2D data resource from a predetermined SA allocation region. The transmission UE 1 transmits the SA 1 (2/3) by using the (middle D2D data resource from the) first D2D data resource. The transmission UE 2 transmits the SA 1 (2/3) by using the (middle D2D data resource from the) second D2D data resource.

In step S108, the reception UE receives the SA 1 (2/3) from each of the transmission UE 1 and the transmission UE 2, and decodes the received SA 1 (2/3).

In step S109, the reception UE considers an ID obtained by joining the ID 1 and the ID 1-2 included in the SA 1 (2/3) that is received by using the first D2D data resource as a new ID 1. Further, the reception UE considers an ID obtained by joining the ID 2 and the ID 2-2 included in the SA 1 (2/3) that is received by using the second D2D data resource as a new ID 2.

In step S110, the reception UE determines whether or not the most recent ID 1 and the most recent ID 2 are the same. When the ID 1 and the ID 2 are not the same (in the case of “No”), the reception UE executes the process of step S106, and when the ID 1 and the ID 2 are the same (in the case of “Yes”), the reception UE executes a process of step S112.

In the present embodiment, the ID 1 indicates “81451943” and the ID 2 indicates “81452943”, which means the IDs are not the same. Therefore, the reception UE executes the process of step S106. The reception UE may not execute process thereafter (steps S112 and S113).

In step S111, the transmission UE transmits the SA 1 (3/3) by using the D2D data resource from a predetermined SA allocation region. The transmission UE 1 transmits the SA 1 (3/3) by using the (last D2D data resource from the) first D2D data resource. The transmission UE 2 transmits the SA 1 (3/3) by using the (last D2D data resource from the) second D2D data resource.

In step S112, the reception UE receives the SA 1 (3/3) from each of the transmission UE 1 and the transmission UE 2, and decodes the received SA 1 (3/3).

In step S113, the reception UE considers an ID obtained by joining the ID 1 and the ID 1-3 included in the SA 1 (3/3) that is received by using the first D2D data resource as a new ID 1. Further, the reception UE considers an ID obtained by joining the ID 2 and the ID 2-3 included in the SA 1 (3/3) that is received by using the second D2D data resource as a new ID 2.

The most recent ID 1 is the same as the UE unique ID maintained by the transmission UE 1, and the most recent ID 2 is the same as the UE unique ID maintained by the transmission UE 2. Therefore, the reception UE is capable of designating a UE that is the transmission source of the SA 1. The reception UE that has designated the transmission source receives the D2D communication data by using the D2D data resource indicated by the SA transmitted by the transmission UE that is desired to be received (S106).

### Other Embodiments

In the above-described embodiment, if located out of coverage, the UE 100-1 may perform any operation of the above-described operation patterns, and if located in coverage, the UE 100-1 may be assigned with a UEID indicating the UE 100-1 by the eNB 200.

In the above-described embodiment, the scheduling assignment may include an identifier indicating the reception-destination UE.

In the described-above embodiment, although an LTE system is described as an example of a mobile communication system, it is not limited to the LTE system, and the present invention may be applied to a system other than the LTE system.

It is noted that the entire content of Japanese Patent Application No. 2014-059276 (filed on Mar. 20, 2014) is incorporated in the present specification by reference.

### INDUSTRIAL APPLICABILITY

As described above, according to the embodiment-based communication control method and user terminal, a reception-side user terminal is capable of receiving appropriate D2D communication data when the D2D communication data is received on the basis of the scheduling assignment received from a transmission-side user terminal, and therefore, the present invention is useful in the field of mobile communication.

1. A communication control method, comprising:
receiving, by a user terminal, a scheduling assignment indicating a location of a radio resource used in a reception of communication data by direct device-to-device communication;
deciding, by the user terminal, a terminal identifier that is different from a terminal identifier indicating another user terminal included in the scheduling assignment, as a terminal identifier indicating the user terminal; and
transmitting, by the user terminal, a scheduling assignment including the decided terminal identifier.

2. The communication control method according to claim 1, further comprising:
deciding, by the user terminal, a terminal identifier candidate that is different from the terminal identifier indicating the another user terminal from among a plurality of terminal identifier candidates, as the terminal identifier indicating the user terminal.

3. The communication control method according to claim 1, wherein
when a terminal identifier candidate decided beforehand is different from the terminal identifier indicating the another user terminal, the user terminal decides the terminal identifier candidate as the terminal identifier indicating the user terminal.

4. The communication control method according to claim 3, wherein
when the terminal identifier candidate decided beforehand is same as the terminal identifier indicating the another user terminal, the user terminal decides a new terminal identifier that is different from the terminal identifier candidate, as the terminal identifier indicating the user terminal.

5. The communication control method according to claim 1, further comprising:
transmitting, by the user terminal, a number corresponding to a transmission order of each of a plurality of communication data, together with each of the plurality of communication data transmitted by direct device-to-device communication.

6. A communication control method, comprising:
periodically transmitting, by a user terminal, a scheduling assignment indicating a location of a radio resource used in a reception of communication data by direct device-to-device communication, wherein
the scheduling assignment includes a number corresponding to a transmission order of the scheduling assignment.

7. The communication control method according to claim 6, wherein
the user terminal includes an initial number decided on the basis of a random number, into the scheduling assignment that is initially transmitted.

8. The communication control method according to claim 6, wherein
the user terminal further includes the terminal identifier indicating the user terminal, into the scheduling assignment, and
the terminal identifier is generated by reducing the size of a unique identifier of the user terminal so that a total amount of information of the number and the terminal identifier becomes equal to or less than a threshold value.

9. A communication control method, comprising:
dividing, by a user terminal, a unique identifier indicating the user terminal into a plurality of identifiers;
transmitting, by the user terminal, one of the plurality of identifiers by including the one of the plurality of identifiers into one of a plurality of scheduling assignments indicating a location of the same radio resource used in a reception of communication data by direct device-to-device communication; and
transmitting, by the user terminal, the communication data after transmitting all of the plurality of identifiers.

10. A user terminal, comprising:
a controller configured to receive a scheduling assignment indicating a location of a radio resource used in a reception of communication data by direct device-to-device communication, wherein
the controller decides a terminal identifier that is different from a terminal identifier indicating another user terminal included in the scheduling assignment, as a terminal identifier indicating the user terminal, and
the controller transmits a scheduling assignment including the decided terminal identifier.

11. A user terminal, comprising:
a transmitter configured to periodically transmit a scheduling assignment indicating a location of a radio resource used in a reception of communication data by direct device-to-device communication, wherein
the scheduling assignment includes a number corresponding to a transmission order of the scheduling assignment.
